(19) United States
(12) Patent Application Publication
(10) Pub. No.: US 2007/0033599 A1
(43) Pub. Date: Feb. 8, 2007

(54) Accelerating apparatus for a disc drive

(76) Inventors: Chi-Hung Chen, Taipei (TW); Chia-Hsuan Chiang, Taipei (TW)

Correspondence Address: RABIN & Berdo, PC, 1101 14TH STREET, NW, SUITE 500, WASHINGTON, DC, 20005, US

(21) Appl. No.: 11/447,958

(22) Filed: Jun. 7, 2006

(30) Foreign Application Priority Data
Aug. 2, 2005 (TW) 94126280

(51) Int. Cl. G11B 17/04

(52) U.S. Cl. 720/602

(57) ABSTRACT

An accelerating apparatus for a disc drive includes a tray, a rotating mechanism and a reading mechanism. The tray is used for loading a disc. The rotating mechanism is disposed on the tray and has a first rotating portion and a second rotating portion. The disc is driven by the first rotating portion to rotate along a first direction. The reading mechanism is driven by the second rotating portion to rotate along a second direction. The reading mechanism is used for reading the disc. The first direction is opposite to the second direction.

This application claims the benefit of Taiwan application Serial No. 94126280, filed Aug. 2, 2005, the subject matter of which is incorporated herein by reference.

### BACKGROUND OF THE INVENTION

1. Field of the Invention

The invention relates in general to an accelerating apparatus, and more particularly to an accelerating apparatus applied to a disc drive.

2. Description of the Related Art

The disc drives currently available on the market include a variety of optical disc drives and optical disc recorders. In order to increase the read/write speed, the rotation speed of stepper motor is designed to be higher and higher. Take the 50× or 52× speed optical disc drive for example, the axial rotation speed can be as high as 10,000 rpm. However, if the rotation speed goes higher, the problems of axial vibration and noises would arise. Currently, the improvement with regard to the rotation speed of stepper motor is very slow.

### SUMMARY OF THE INVENTION

It is therefore an object of the invention to provide an accelerating apparatus for a disc drive. The design of the direction of the rotation of the disc and the reading mechanism doubles the relative rotation speed and accelerates the read/write ability and efficiency for the disc drive.

The embodiment of the invention achieves the above-identified object by providing an accelerating apparatus for a disc drive. The accelerating apparatus includes a tray, a rotating mechanism and a reading mechanism. The tray is used for loading a disc. The rotating mechanism is disposed on the tray and has a first rotating portion and a second rotating portion. The first rotating portion and the second rotating portion rotate around the same axis. The disc is driven by the first rotating portion to rotate along a first direction. The reading mechanism is driven by the second rotating portion to rotate along a second direction. The reading mechanism is used for reading the disc. The first direction is opposite to the second direction.

The embodiment of the invention further achieves the above-identified object by providing a disc drive. The disc drive includes a tray, a rotating mechanism and a reading mechanism. The tray is used for loading a disc. The rotating mechanism is disposed on the tray and has a first rotating portion and a second rotating portion. The first rotating portion and the second rotating portion rotate around the same axis. The disc is driven by the first rotating portion to rotate along a first direction. The reading mechanism is driven by the second rotating portion to rotate along a second direction. The reading mechanism is used for reading the disc. The first direction is opposite to the second direction.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates an exploded diagram of a disc drive according to a preferred embodiment of the invention;

FIG. 2A illustrates a top view of a reading mechanism and a rotating mechanism of the disc drive in FIG. 1; and

FIG. 2B illustrates a side view of the reading mechanism and the rotating mechanism of the disc drive in FIG. 1.

### DETAILED DESCRIPTION OF THE INVENTION

The embodiment of the invention provides an accelerating apparatus for a disc drive. The disc and the reading mechanism rotate along opposite directions so as to accelerate the read/write speed. The reading mechanism can be a read/write mechanism, so the disc drive can be an optical disc drive or an optical disc recorder. The following embodiment is exemplified by the optical disc drive.

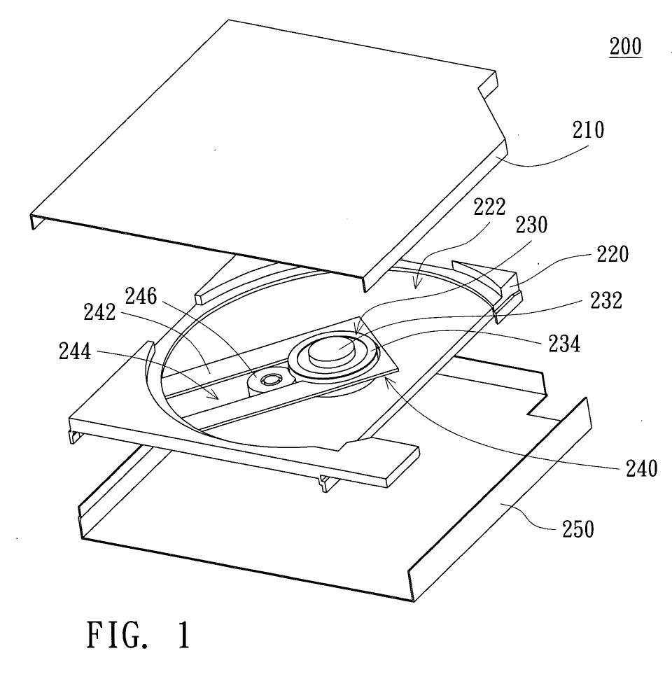

Referring to FIG. 1, an exploded diagram of a disc drive according to a preferred embodiment of the invention is shown. The optical disc drive 200 includes a top casing 210 and a bottom casing 250. The top casing 210 and the bottom casing 250 are coupled to form an accommodation space for accommodating the tray 220, the rotating mechanism 230 and the reading mechanism 240. The tray 220 is used for loading a disc (not shown in the diagram), and preferably has a circular loading area 222. The rotating mechanism 230 is disposed on the tray 220. The reading mechanism 240 includes a carrier 242 and a pick-up head 246. The pick-up head 246 is disposed on the carrier 242. The carrier 242 further has a rail 244. The pick-up head 246 reciprocates on the rail 244 In the present embodiment of the invention, the rail 244 is preferably rectangular, the pick-up head 246 is preferably a reciprocating pick-up head, and the carrier 242 is preferably an approximate rectangular structure with an arced edge.

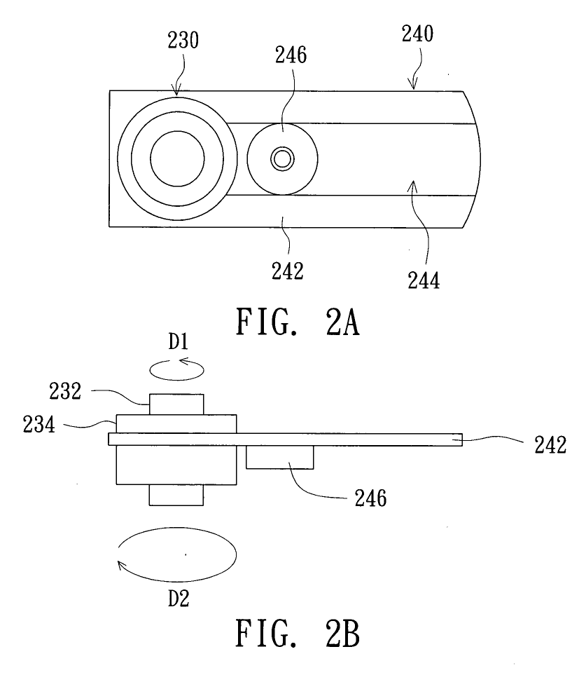

Referring to both FIG. 2A and FIG. 2B, a top view and a side view of a reading mechanism and a rotating mechanism of the disc drive in FIG. 1 are respectively shown. The rotating mechanism 230 has a first rotating portion 232 and a second rotating portion 234. The first rotating portion 232 and the second rotating portion 234 rotate around the same axis. The first rotating portion 232 is used for driving a disc (not shown in the diagram) to rotate along a first direction D1. The reading mechanism 240 is driven by the second rotating portion 234 to rotate along a second direction D2 opposite to the first direction D1 for enabling the reading mechanism 240 to read a disc disposed in the loading area 222 in FIG. 1.

In the present embodiment of the invention, the tray 220 has a preferred circular loading area 222, the carrier 242 of the reading mechanism 240 is preferably an approximate rectangular structure with an arced edge, and the arced edge is corresponding to the peripheral of the loading area 222. When the disc is driven by the first rotating portion 232 of the rotating mechanism 230 to rotate along the first direction D1, the reading mechanism 240 is driven by the second rotating portion 234 to rotate along the second direction D2 within the loading area 222. Meanwhile, an arced edge of the carrier 242 rotates along the peripheral of the circular loading area 222, and the pick-up head 246 can reciprocate on the rail 244 of the carrier 242 for reading data.

Any one who is skilled in the technology of the present embodiment of the invention will understand that the technology of the invention is not limited thereto. For example, the first direction D1 can either be anti-clockwise or clockwise. In the present embodiment of the invention, the optical disc drive 200 can be exemplified by an optical disc recorder with the pick-up head 246 being replaced by a read/write head to improve the read/write efficiency of the disc.

According to the design of the accelerating apparatus for a disc drive disclosed in the above embodiment of the invention, the rotating mechanism 230 is equipped with two rotating portions having different directions of rotation. When the disc is driven to rotate, the reading mechanism 240 is driven to rotate in an opposite direction for doubling the relative rotation speed between the reading mechanism 240 and the disc (not shown in the diagram) and accelerating the read/write ability and efficiency for the optical disc drive 200.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An accelerating apparatus for a disc drive, comprising:
a tray used for loading a disc;
a rotating mechanism disposed on the tray, wherein the rotating mechanism has a first rotating portion and a second rotating portion, the first rotating portion and the second rotating portion rotate around the same axis, and the disc is driven by the first rotating portion to rotate along a first direction; and
a reading mechanism driven by the second rotating portion to rotate along a second direction for reading the disc;
wherein, the first direction is opposite to the second direction.

2. The apparatus according to claim 1, wherein the tray has a loading area, and the reading mechanism rotates within the loading area.

3. The apparatus according to claim 1, wherein the reading mechanism further comprises:
a carrier connected to the second rotating portion; and
a pick-up head disposed on the carrier.

4. The apparatus according to claim 3, wherein the carrier has a rail, and the pick-up head reciprocates on the rail.

5. The apparatus according to claim 4, wherein the rail is rectangular.

6. The apparatus according to claim 3, wherein the pick-up head is a reciprocating pick-up head.

7. The apparatus according to claim 3, wherein the carrier is an approximate rectangular structure with an arced edge.

8. The apparatus according to claim 1, wherein the first direction is clockwise.

9. The apparatus according to claim 1, wherein the first direction is anti-clockwise.

10. The apparatus according to claim 1, wherein the disc drive further has a top casing and a bottom casing, and the top casing and the bottom casing form an accommodation space for accommodating the tray, the rotating mechanism and the reading mechanism.

11. The apparatus according to claim 1, wherein the disc drive is an optical disc drive.

12. The apparatus according to claim 1, wherein the reading mechanism is a read/write mechanism.

13. A disc drive, comprising:
a tray used for loading a disc;
a rotating mechanism disposed on the tray, wherein the rotating mechanism has a first rotating portion and a second rotating portion, the first rotating portion and the second rotating portion rotate around the same axis, and the disc is driven by the first rotating portion to rotate along a first direction; and
a reading mechanism driven by the second rotating portion to rotate along a second direction for reading/writing the disc;
wherein, the first direction is opposite to the second direction.

14. The disc drive according to claim 13, wherein the tray has a loading area, and the read/write mechanism rotates within the loading area.

15. The disc drive according to claim 13, wherein the reading mechanism further comprises:
a carrier connected to the second rotating portion; and
a read/write head disposed on the carrier.

16. The disc drive according to claim 15, wherein the carrier has a rail, and the reading mechanism reciprocates on the rail.

17. The disc drive according to claim 16, wherein the rail is rectangular.

18. The disc drive according to claim 15, wherein the read/write head is a reciprocating read/write head.

19. The disc drive according to claim 13, wherein the reading mechanism is an approximate rectangular structure with an arced edge.

20. The disc drive according to claim 13, wherein the first direction is clockwise.

21. The disc drive according to claim 13, wherein the first direction is anti-clockwise.

22. The disc drive according to claim 13, wherein the drive further has a top casing and a bottom casing, and the top casing and the bottom casing form an accommodation space for accommodating the tray, the rotating mechanism and the reading mechanism.

23. The disc drive according to claim 13, wherein the reading mechanism is a read/write mechanism.
